(19) United States
(12) Patent Application Publication
(10) Pub. No.: US 2015/0239256 A1
(43) Pub. Date: Aug. 27, 2015

(54) INTERMEDIATE MEMBER SURFACE COMPOSITION FOR SENSING BY AN IMAGE SENSOR

(71) Applicant: Xerox Corporation, Norwalk, CT (US)

(72) Inventors: Matthew Michael Kelly, West Henrietta, NY (US); David Joseph Gervasi, Pittsford, NY (US); Santokh S. Badesha, Pittsford, NY (US); Jeffrey J. Folkins, Rochester, NY (US); Howard A. Mizes, Pittsford, NY (US)

(73) Assignee: Xerox Corporation, Norwalk, CT (US)

(21) Appl. No.: 14/187,434

(22) Filed: Feb. 24, 2014

(51) Int. Cl. B41J 2/21

(52) U.S. Cl. CPC B41J 2/2121

(57) ABSTRACT

There is described a method of operating an aqueous ink jet printing apparatus. The printing apparatus includes a member defining a reflective imaging surface wherein the imaging surface is substantially white or grey in the visible spectrum and wherein the imaging surface has an optical density variation of less than about 0.3. The method includes a photosensor array disposed to receive light reflected from the reflective imaging surface. The method includes ejecting aqueous ink onto the reflective imaging surface using a printhead and forming aqueous ink drops on the surface of the rotating member. The method includes generating image data from the reflecting imaging surface using the photosensor array. The method includes identifying a parameter from the generated image data that is not within specification

### BACKGROUND

1. Field of Use

This disclosure relates generally to aqueous indirect inkjet printers, and, in particular, to image quality evaluation and correction in aqueous ink inkjet printing.

2. Background

In general, inkjet printing machines or printers include at least one printhead that ejects drops or jets of liquid ink onto a recording or image forming surface. An aqueous inkjet printer employs water-based or solvent-based inks in which pigments or other colorants are suspended or in solution. Once the aqueous ink is ejected onto an image receiving surface by a printhead, the water or solvent is evaporated to stabilize the ink image on the image receiving surface. When aqueous ink is ejected directly onto media, the aqueous ink tends to soak into the media when it is porous, such as paper, and change the size and location of the drop of ink from its intended position. To address this issue, a printer that ejects ink onto an intermediate surface has been developed. These printers are referred to as indirect printers or transfix printers. One such printer ejects ink onto a rotating intermediate imaging surface, which is usually in the form of a rotating drum or endless belt. The ink is dried or partially dried on the member and then transferred to media. Such a printer avoids the changes in media properties that occur in response to media contact with the water or solvents in aqueous ink. Indirect printers also reduce the effect of variations in other media properties that arise from the use of widely disparate types of paper and films used to hold the final ink images.

In these indirect printers, the intermediate imaging surface has two competing requirements. The ink should adhere strongly to the location to which it was directed, yet be able to transfer from the intermediate imaging surface member to the media after it is dried. These goals can be achieved by applying a coating material to the intermediate imaging surface or “blanket.” Coating materials have a variety of purposes that include wetting the intermediate imaging surface, inducing solids to precipitate out of the liquid ink, providing a solid matrix for the colorant in the ink, and/or aiding in the release of the printed image from the intermediate imaging surface. Because the intermediate imaging surfaces are likely to be surfaces with low surface energy, reliable coating is a challenge. If the coating is too thin, it may fail to form a layer adequate to support an ink image. If the coating is too thick, a disproportionate amount of the coating may be transferred to media with the final image. Image defects arising from either phenomenon may significantly degrade final image quality.

Parameters other than coating thicknesses also affect image quality in an aqueous indirect inkjet printer. These parameters include coalescence of the ejected ink drops, spread of the ink drops, and inter-color bleed of adjacent ink drops in the process and cross process directions. These issues are not encountered or are not as severe in printing with other inks, such as solid or phase change inks, which become solid upon contact with the media. Also, the ink image changes as the ink dries. Consequently, evaluation of ink image status for high efficiency transfer of an ink image and coherence of the ink image for transfer is important and varies depending upon the position of the ink image in the print cycle. Moreover, after the ink image is transferred, the efficiency of the transfer and any subsequent cleaning of the intermediate imaging surface require evaluation as well. Analyzing the transfer of the ink image to the media and measuring the overall quality of the ink image on the media can also be important. Structuring printers and configuring the components in an aqueous printer to evaluate and adjust these various parameters at appropriate places in a printer remains a significant goal for making aqueous printers that reliably produce images on media with acceptable quality.

### SUMMARY

There is described a method of operating an aqueous ink jet printing apparatus. The printing apparatus includes a member defining a reflective imaging surface wherein the reflective imaging surface is substantially white or grey in the visible spectrum and wherein the imaging surface has an optical density variation of less than about 0.3. The method includes a photosensor array disposed to receive light reflected from the reflective imaging surface. The method includes ejecting aqueous ink onto the reflective imaging surface using a printhead and forming aqueous ink drops on the surface of the rotating member. The method includes generating image data from the reflecting imaging surface using the photosensor array. The method includes identifying a parameter from the generated image data that is not within specification.

There is described a printer including at least one printhead configured to eject aqueous ink drops. The printer includes a rotating member positioned to rotate in front of the at least one printhead to enable the at least one printhead to eject aqueous ink drops onto the surface of the rotating member and form an aqueous ink image on the surface of the rotating member. The rotating member includes a reflective imaging surface wherein the reflective imaging surface is substantially white or grey in the visible spectrum and wherein the imaging surface has an optical density variation of less than about 0.3. The printer includes at least one optical sensor disposed to receive light reflected from the imaging surface and to generate image data from the aqueous ink image. The printer includes. A controller operatively connected to the at least one optical sensor, the controller being configured to receive the image data and identify a parameter from the generated image data that is not within specification.

There is described a method of operating an aqueous ink jet printing apparatus. The method includes a printing apparatus having a member defining a reflective imaging surface wherein the imaging surface is substantially white or grey in the visible spectrum and wherein the imaging surface has an optical density variation of less than about 0.3. The method includes a photosensor array disposed to receive light reflected from the reflective imaging surface. The method includes ejecting aqueous ink onto the reflective imaging surface using a printhead and forming an aqueous ink drops on the surface of the rotating member, wherein the aqueous ink drops are of a cyan color, a magenta color, a yellow color and a black color. The method includes generating image data from the reflecting imaging surface using the photosensor array. The method includes identifying a parameter from the generated image data that is not within specification.

### BRIEF DESCRIPTION OF THE DRAWINGS

FIG. 1 is a schematic drawing of an aqueous indirect inkjet printer that produces ink images on media sheets.

It should be noted that some details of the figures have been simplified and are drawn to facilitate understanding of the embodiments rather than to maintain strict structural accuracy, detail, and scale.

### DETAILED DESCRIPTION

For a general understanding of the present embodiments, reference is made to the drawings. In the drawings, like reference numerals have been used throughout to designate like elements. As used herein, the terms “printer,” “printing device,” or “imaging device” generally refer to a device that produces an image with one or more colorants on print media and may encompass any such apparatus, such as a digital copier, bookmaking machine, facsimile machine, multi-function machine, or the like, which generates printed images for any purpose. Image data generally include information in electronic form which are rendered and used to operate the inkjet ejectors to form an ink image on the print media. These data can include text, graphics, pictures, and the like. The operation of producing images with colorants on print media, for example, graphics, text, photographs, and the like, is generally referred to herein as printing or marking. Phase-change ink printers use phase-change ink, also referred to as a solid ink, which is in a solid state at room temperature but melts into a liquid state at a higher operating temperature. The liquid ink drops are printed onto an image receiving surface in either a direct or indirect printer.

The term “printhead” as used herein refers to a component in the printer that is configured with inkjet ejectors to eject ink drops onto an image receiving surface. A typical printhead includes a plurality of inkjet ejectors that eject ink drops of one or more ink colors onto the image receiving surface in response to firing signals that operate actuators in the inkjet ejectors. The inkjets are arranged in an array of one or more rows and columns. In some embodiments, the inkjets are arranged in staggered diagonal rows across a face of the printhead. Various printer embodiments include one or more printheads that form ink images on an image receiving surface. Some printer embodiments include a plurality of printheads arranged in a print zone. An image receiving surface, such as a print medium or the surface of an intermediate member that carries an ink image, moves past the printheads in a process direction through the print zone. The inkjets in the printheads eject ink drops in rows in a cross-process direction, which is perpendicular to the process direction across the image receiving surface. As used in this document, the term “aqueous ink” includes liquid inks in which colorant is in solution with water and/or one or more solvents.

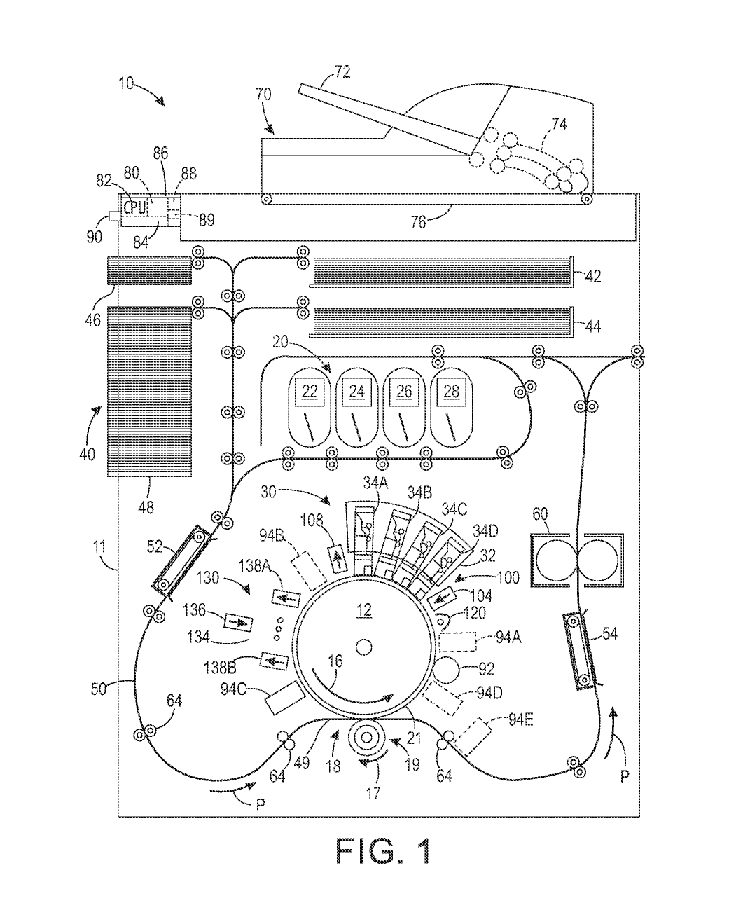

FIG. 1 illustrates a high-speed aqueous ink image producing machine or printer 10. As illustrated, the printer 10 is an indirect printer that forms an ink image on a surface of a blanket 21 mounted about an intermediate rotating member 12 and then transfers the ink image to media passing through a nip 18 formed with the blanket 21 and intermediate rotating member 12. A print cycle is now described with reference to the printer 10. As used in this document, “print cycle” refers to the operations of a printer to prepare an imaging surface for printing, ejection of the ink onto the prepared surface, treatment of the ink on the imaging surface to stabilize and prepare the image for transfer to media, and transfer of the image from the imaging surface to the media.

The printer 10 includes a frame 11 that supports directly or indirectly operating subsystems and components, which are described below. The printer 10 includes an intermediate rotating member 12 that is shown in the form of a drum, but can also be configured as a supported endless belt. The intermediate rotating member 12 has an outer blanket 21 mounted about the circumference of the member 12. The blanket moves in a direction 16 as the member 12 rotates. A transfix roller 19 rotatable in the direction 17 is loaded against the surface of blanket 21 to form a transfix nip 18, within which ink images formed on the surface of blanket 21 are transfixed onto a media sheet 49. The transfer member 12 can be of any suitable configuration. Examples of suitable configurations include a sheet, a film, a web, a foil, a strip, a coil, a cylinder, a drum, an endless strip, a circular disc, a drelt (a cross between a drum and a belt), a belt including an endless belt, an endless seamed flexible belt, and an endless seamed flexible imaging belt. The transfer member 12 can be a single layer or multiple layers.

The surface 21 of transfer member 12 is formed of a material having a relatively low surface energy to facilitate transfer of the ink image from the surface 21 to the media sheet 49 in the nip 18. Such materials include silicone, fluorosilicone, fluoroelastomers such as Viton®. Low energy surfaces, however, do not aid in the formation of good quality ink images as they do not spread ink drops as well as high energy surfaces. Disclosed in more detail below is a method and apparatus that improves the spreading ability of the ink to provide good ink images while allowing for proper release of the ink images onto the recording substrate 49. A surface maintenance unit (SMU) 92 removes residual ink left on the surface 21 of the blanket 12 after the ink images are transferred to the media sheet 49. The low energy surface 21 of the blanket does not aid in the formation of good quality ink images because drops of ink form a high contact angle and do not wet the surface and spread as well as they do on high surface energy materials. Consequently, some embodiments of SMU 92 also apply a coating to the blanket surface. The coating helps aid in wetting the surface of the blanket, inducing solids to precipitate out of the liquid ink, providing a solid matrix for the colorant in the ink, and aiding in the release of the ink image from the blanket. Such coatings include surfactants, starches, and the like. In embodiments a dryer (not shown) is included after in the SMU 92 when a coating is applied. In other embodiments, a surface energy applicator 120, which is described in more detail below, operates to treat the surface of blanket for improved formation of ink images without requiring application of a coating by the SMU 92.

The SMU 92 can include a coating applicator having a reservoir with a fixed volume of coating material and a resilient donor roller, which can be smooth or porous and is rotatably mounted in the reservoir for contact with the coating material. The donor roller can be a smooth elastomeric roller or can be of an anilox type. The coating material is applied to the surface 21 of the blanket 12 to form a thin layer on the blanket surface. The SMU 92 is operatively connected to a controller 80, described in more detail below, to enable the controller to operate the donor roller, metering blade and cleaning blade selectively to deposit and distribute the coating material onto the surface of the blanket and remove un-transferred ink pixels from the surface 21 of the blanket 12. Alternatively a separate system positioned against the surface 21 of blanket 12 prior to SMU 92 could serve the cleaning function of removing residual ink or debris from the blanket enabling the SMU 92 system to concentrate on the application of coating.

Continuing with the general description, the printer 10 includes an optical sensor 94A, also known as an image-on-drum (“IOD”) sensor, that is configured to detect light reflected from the surface 21 of the transfer member 12, the coating applied to the surface 21 as well as any ink that may have been applied to the surface 12 as the member 12 rotates past the sensor. The optical sensor 94C includes a linear array of individual optical detectors that are arranged in the cross-process direction across the surface 21 of the transfer member 12. The optical sensor 94C generates digital image data corresponding to light that is reflected from the surface 21. The optical sensor 94C generates a series of rows of image data, which are referred to as “scanlines,” as the transfer member 12 rotates in the direction 16 past the optical sensor 94C. In one embodiment, each optical detector in the optical sensor 94C further comprises three sensing elements that are sensitive to frequencies of light corresponding to red, green, and blue (RGB) reflected light colors. The optical sensor 94C also includes illumination sources that shine red, green, blue or white light onto the surface 21. The optical sensor 94C shines complementary colors of light onto the image receiving surface to enable detection of different ink colors using the RGB elements in each of the photodetectors. The image data generated by the optical sensor 94C is analyzed by the controller 80 or other processor in the printer 10 to identify the thickness of ink image and wetting enhancement coating (explained in more detail below) on the surface 21 and the area coverage. The thickness and coverage can be identified from either specular or diffuse light reflection from the blanket surface and coating. Other optical sensors, such as 94B, 94A, and 94D, are similarly configured and can be located in different locations around the surface 21 to identify and evaluate other parameters in the printing process, such as missing or inoperative inkjets and ink image formation prior to image drying (94B), ink image treatment for image transfer (94C), the efficiency of the ink image transfer (94D) and pre-coating uniformity (94A). Alternatively, some embodiments can include an optical sensor to generate additional data that can be used for evaluation of the image quality on the media (94E).

The printer 10 also can include a surface energy applicator 120 positioned next to the surface 21 of the transfer member 12 at a position immediately prior to the surface 21 entering the print zone formed by printhead modules 34A-34D. The surface energy applicator 120 can be, for example, a corotron, a scorotron, or a biased charge roller. The surface energy applicator 120 is configured to emit an electric field between the applicator 120 and the surface 21 that is sufficient to ionize the air between the two structures and apply negatively charged particles, positively charged particles, or a combination of positively and negatively charged particles to the surface 21. The electric field and charged particles increase the surface energy of the blanket surface and coating. The increased surface energy of the surface 21 enables the ink drops subsequently ejected by the printheads in the modules 34A-34D to adhere to the surface 21 and coalesce.

The printer 10 includes an airflow management system 100, which generates and controls a flow of air through the print zone. The airflow management system 100 includes a printhead air supply 104 and a printhead air return 108. The printhead air supply 104 and return 108 are operatively connected to the controller 80 or some other processor in the printer 10 to enable the controller to manage the air flowing through the print zone. The air supply 104 and air return 108 can be positioned between the modules (34A-34D) in embodiments. This regulation of the air flow helps prevent evaporated solvents and water in the ink from condensing on the printhead and helps attenuate heat in the print zone to reduce the likelihood that ink dries in the inkjets, which can clog the inkjets. The airflow management system 100 can also include sensors to detect humidity and temperature in the print zone to enable more precise control of the air supply 104 and return 108 to ensure optimum conditions within the print zone. Controller 80 or some other processor in the printer 10 can also enable control of the system 100 with reference to ink coverage in an image area or even to time the operation of the system 100 so air only flows through the print zone when an image is not being printed. The temperature and humidity of the input air can be controlled, generally with the humidity being low and the temperature being colder than the printheads.

The high-speed aqueous ink printer 10 also includes an aqueous ink supply and delivery subsystem 20 that has at least one source 22 of one color of aqueous ink. Since the illustrated printer 10 is a multicolor image producing machine, the ink delivery system 20 includes four (4) sources 22, 24, 26, 28, representing four (4) different colors CYMK (cyan, yellow, magenta, black) of aqueous inks. In the embodiment of FIG. 1, the printhead system 30 includes a printhead support 32, which provides support for a plurality of printhead modules, also known as print box units, 34A through 34D. Each printhead module 34A-34D effectively extends across the width of the intermediate transfer member 12 and ejects ink drops onto the surface 21. A printhead module can include a single printhead or a plurality of printheads configured in a staggered arrangement. Each printhead module is operatively connected to a frame (not shown) and aligned to eject the ink drops to form an ink image on the surface 21. The printhead modules 34A-34D can include associated electronics, ink reservoirs, and ink conduits to supply ink to the one or more printheads. In the illustrated embodiment, conduits (not shown) operatively connect the sources 22, 24, 26, and 28 to the printhead modules 34A-34D to provide a supply of ink to the one or more printheads in the modules. As is generally familiar, each of the one or more printheads in a printhead module can eject a single color of ink. In other embodiments, the printheads can be configured to eject two or more colors of ink. For example, printheads in modules 34A and 34B can eject cyan and magenta ink, while printheads in modules 34C and 34D can eject yellow and black ink. The printheads in the illustrated modules are arranged in two arrays that are offset, or staggered, with respect to one another to increase the resolution of each color separation printed by a module. Such an arrangement enables printing at twice the resolution of a printing system only having a single array of printheads that eject only one color of ink. Although the printer 10 includes four printhead modules 34A-34D, each of which has two arrays of printheads, alternative configurations include a different number of printhead modules or arrays within a module.

After the printed image on the surface 21 exits the print zone, the image passes under an image dryer 130. The image dryer 130 includes an infrared heater 134, a heated air source 136, and air returns 138A and 138B. The infrared heater 134 applies infrared heat to the printed image on the surface 21 of the transfer member 12 to evaporate water or solvent in the ink. The heated air source 136 directs heated air over the ink to supplement the evaporation of the water or solvent from the ink. The air is then collected and evacuated by air returns 138A and 138B to reduce the interference of the air flow with other components in the printing area.

As further shown, the printer 10 includes a recording media supply and handling system 40 that stores, for example, one or more stacks of paper media sheets of various sizes. The recording media supply and handling system 40, for example, includes sheet or substrate supply sources 42, 44, 46, and 48. In the embodiment of printer 10, the supply source 48 is a high capacity paper supply or feeder for storing and supplying image receiving substrates in the form of cut media sheets 49, for example. The recording media supply and handling system 40 also includes a substrate handling and transport system 50 that has a media pre-conditioner assembly 52 and a media post-conditioner assembly 54. Assembly 52 pre-conditioner can include a heater to increase the temperature of the media. The printer 10 includes an optional conditioning device 60 to apply additional heat and/or pressure to the print medium after the print medium passes through the transfix nip 18. In the embodiment of FIG. 1, the printer 10 includes an original document feeder 70 that has a document holding tray 72, document sheet feeding and retrieval devices 74, and a document exposure and scanning system 76.

Operation and control of the various subsystems, components and functions of the machine or printer 10 are performed with the aid of a controller or electronic subsystem (ESS) 80. The ESS or controller 80 is operably connected to the image receiving member 12, the printhead modules 34A-34D (and thus the printheads), the substrate supply and handling system 40, the substrate handling and transport system 50, and, in some embodiments, the one or more optical sensors 94A-94E. The ESS or controller 80, for example, is a self-contained, dedicated mini-computer having a central processor unit (CPU) 82 with electronic storage 84, and a display or user interface (UI) 86. The ESS or controller 80, for example, includes a sensor input and control circuit 88 as well as a pixel placement and control circuit 89. In addition, the CPU 82 reads, captures, prepares and manages the image data flow between image input sources, such as the scanning system 76, or an online or a work station connection 90, and the printhead modules 34A-34D. As such, the ESS or controller 80 is the main multi-tasking processor for operating and controlling all of the other machine subsystems and functions, including the printing process discussed below.

The controller 80 can be implemented with general or specialized programmable processors that execute programmed instructions. The instructions and data required to perform the programmed functions can be stored in memory associated with the processors or controllers. The processors, their memories, and interface circuitry configure the controllers to perform the operations described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image data for an image to be produced are sent to the controller 80 from either the scanning system 76 or via the online or work station connection 90 for processing and generation of the printhead control signals output to the printhead modules 34A-34D. Additionally, the controller 80 determines and/or accepts related subsystem and component controls, for example, from operator inputs via the user interface 86, and accordingly executes such controls. As a result, aqueous ink for appropriate colors are delivered to the printhead modules 34A-34D. Additionally, pixel placement control is exercised relative to the surface 21 to form ink images corresponding to the image data, and the media, which can be in the form of media sheets 49, are supplied by any one of the sources 42, 44, 46, 48 and handled by recording media transport system 50 for timed delivery to the nip 18. In the nip 18, the ink image is transferred from the surface 21 of the transfer member 12 to the media substrate within the transfix nip 18.

Although the printer 10 in FIG. 1 is described as having a blanket 12 mounted about an intermediate rotating member, other configurations of an image receiving surface can be used. For example, the intermediate rotating member can have a surface integrated into its circumference that enables an aqueous ink image to be formed on the surface. Alternatively, a blanket 21 could be configured as an endless belt and rotated as the member is in FIG. 1. Other variations of these structures can be configured for this purpose. As used in this document, the term “intermediate imaging surface” includes these various configurations.

In some printing operations, a single ink image can cover the entire surface 21 (single pitch) or a plurality of ink images can be deposited on the surface 21 (multi-pitch). In a multi-pitch printing architecture, the surface 21 of the transfer member 12 (also referred to as image receiving member) can be partitioned into multiple segments, each segment including a full page image in a document zone (i.e., a single pitch) and inter-document zones that separate multiple pitches formed on the surface 21. For example, a two pitch image receiving member includes two document zones that are separated by two inter-document zones around the circumference of the surface 21. Likewise, for example, a four pitch image receiving member includes four document zones, each corresponding to an ink image formed on a single media sheet, during a pass or revolution of the surface 21.

Once an image or images have been formed on the surface under control of the controller 80, the illustrated inkjet printer 10 operates components within the printer to perform a process for transferring and fixing the image or images from the surface 21 to media. In the printer 10, the controller 80 operates actuators to drive one or more of the rollers 64 in the media transport system 50 to move the media sheet 49 in the process direction P to a position adjacent the transfix roller 19 and then through the transfix nip 18 between the transfix roller 19 and the surface 21 of transfer member 12. The transfix roller 19 applies pressure against the back side of the recording media 49 in order to press the front side of the recording media 49 against the surface 21 of the transfer member 12. Although the transfix roller 19 can also be heated, in the embodiment of FIG. 1, the transfix roller 19 is unheated. Instead, the pre-heater assembly 52 for the media sheet 49 is provided in the media path leading to the nip. The pre-conditioner assembly 52 conditions the media sheet 49 to a predetermined temperature that aids in the transferring of the image to the media, thus simplifying the design of the transfix roller. The pressure produced by the transfix roller 19 on the back side of the heated media sheet 49 facilitates the transfixing (transfer and fusing) of the image from the transfer member 12 onto the media sheet 49.

The rotation or rolling of both the blanket 12 and the transfix roller 19 not only transfixes the images onto the media sheet 49, but also assists in transporting the media sheet 49 through the nip. The blanket 12 continues to rotate to continue the transfix process for the images previously applied to the coating and blanket 12.

By providing a wetting enhancement coating (WEC) and drying the coating to form a higher surface energy coating on the surface 21 of the transfer member 12, improved wetting of the ink image on the transfer member 12 is obtained. The ink image is applied to the wetting enhancement coating film. The dried film is incompatible with the ink and/or is thick enough to avoid the coating being completely re-dissolved into the ink.

As shown and described above the transfer member 12 or image receiving member initially receives the ink jet image. After ink drying, the transfer member 12 releases the image to the final print substrate during a transfer step in the nip 18. The transfer step is improved when the surface 21 of the transfer member 12 has a relatively low surface energy. However, a surface 21 with low surface energy works against the desired initial ink wetting (spreading) on the transfer member 12. Unfortunately, there are two conflicting requirements of the surface 21 of transfer member 12. The first aims for the surface to have high surface energy causing the ink to spread and wet (i.e. not bead-up). The second requirement is that the ink image once dried has minimal attraction to the surface 21 of transfer member 12 so as to achieve maximum transfer efficiency (target is 100%), this is best achieved by minimizing the surface 21 surface energy.

As noted above, an aqueous printer having the structure shown in FIG. 1 can have one optical sensor 94A, 94B, 94C, or 94D, or any combination or permutation of image sensors at these positions about the transfer member 12. The advantage of having multiple image sensors is that any subsystem affecting the print cycle can be monitored without having to disable the ability to print continuously. When a subsystem that needs to be monitored is not immediately followed by an optical sensor, then the subsystems that lie between that subsystem and the next available optical sensor must be disengaged. An operation must occur with respect to a portion of the intermediate imaging surface followed by continued rotation of the intermediate imaging surface so that portion reaches the optical sensor, which is operated to generate image data of the surface that can be analyzed to evaluate the operation. The intermediate imaging surface then continues to rotate until the portion of the surface that was imaged reaches the next operational station position so an operation can be performed. The surface is rotated until that portion on which the operation occurred reaches the optical sensor for imaging so the next operation performed on the surface can be evaluated. This requirement disables the ability to print for at least one rotation of the drum any time a subsystem needs to be monitored. For example, in a printer embodiment having a single optical sensor and the need to monitor the surface applicator 120, the intermediate imaging surface continues rotation following surface treatment of a portion of the surface by the surface energy applicator 120 without operating the printheads 34A to 34D to eject ink or activating the heater 130 so the treated portion of the imaging surface can be imaged by optical sensor 94C, when optical sensor 94C is the only optical sensor in the printer. This example can be extended to complete a multi-pass print cycle that enables printer embodiments with only one optical sensor or less than all of the optical sensors 94A, 94B, 94C, and 94D to generate image data of the intermediate imaging surface and scrutinize the performance of various components in the printer.

In printers that have all of the optical sensors 94A, 94B, 94C, and 94D, image data of the imaging surface can be generated after each of the operations of surface treatment and printing with applicator 120 and printheads 34A-34D, drying the ink image with heater 130, transferring the image at nip 18, and cleaning the surface with SMU 92. If evaluation of the surface treatment needs to be tested independently of printing, then another optical sensor could be installed between the applicator 120 and the printhead 34D, although the characteristics on the imaging surface provide good insight into the effectiveness of the surface treatment. Additionally, optical sensor 94E is provided if the quality of the ink image on media is to be tested.

In solid ink printing, one optical sensor positioned after a print zone is effective for evaluating operation of the printer because the ink “freezes” and remains relatively stationary on the imaging surface after the ejected ink lands on the surface. Aqueous ink is more mobile on the imaging surface until an adequate amount of water and/or solvent has been removed. Additionally, the printing of aqueous ink drops can be susceptible to problems, such as bleeding into one another. The bleeding of ink drops leads to perceptible defects in the images on the media. In solid ink printing, most of the image defects arise from printhead issues, such as printhead alignment, missing inkjets, printhead intensities, and the like. Consequently, an optical sensor positioned almost anywhere following the print zone generates image data that can be analyzed to detect these issues. In aqueous printers, image defects arising from aqueous ink characteristics can be caused by the components treating the imaging surface, the environment in the print zone between the printheads and the imaging surface, the dryer effectiveness, and the transfer efficiencies. Thus, the imaging surface in aqueous inkjet printers needs to be imaged with and without ink and at different positions during a single print cycle to evaluate the myriad subsystems that affect image quality in the printer.

To address these issues affecting image quality in aqueous printers, the printer of FIG. 1 includes multiple optical sensors to generate image data of the blanket 12 at different positions in a single print cycle or operate a single optical sensor one or multiple times for a single print cycle that is performed in one or multiple revolutions of the blanket. Such operation of the optical sensor(s) enables multiple components at different positions in the print cycle to be tested and adjusted to address image quality issues. Additionally, the light source in the optical sensors can be oriented with reference to the blanket surface to detect specular reflection or diffuse reflection. Also, the color of the light in one or more sensors can be adjusted to enhance the visibility of specific inks or blankets, and multiple color light sources associated with one or more sensors can be sequentially used to enhance detection of the various ink colors such as complementary colors.

The imaging member disclosed herein includes a reflective imaging surface 21 that is substantially white or grey. When part of the surface is covered with ink, the optical density will generally increase because the ink will absorb some fraction of the incident light. If the surface is not uniformly white or gray, but has a spatial variation, then the spatial variation will act as a noise source that makes the detection of the ink drop more difficult. Therefore, the reflective imaging surface 21 has an optical density variation of less than about 0.3 to allow for an adequate signal to noise ratio to enable detection of the aqueous ink drops jetted on the imaging surface 21.

Examples of polymeric materials used for as the surface 21 in transfer member 12 include silicones, fluorosilicones, polyimides, fluoropolymers such as polytetrafluoroethylene and some hybrid materials. Fluorosilicones and silicones include room temperature vulcanization (RTV) silicone rubbers, high temperature vulcanization (HTV) silicone rubbers, and low temperature vulcanization (LTV) silicone rubbers. These rubbers are known and readily available commercially, such as SILASTIC 735 black RTV and SILASTIC 732 RTV, both from Dow Corning; 106 RTV Silicone Rubber and 90 RTV Silicone Rubber, both from General Electric; and JCR6115CLEAR HTV and SE4705U HTV silicone rubbers from Dow Corning Toray Silicones. Other suitable silicone materials include siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182. Commercially available LSR rubbers include Dow Corning Q3-6395, Q3-6396, SILASTIC® 590 LSR, SILASTIC® 591 LSR, SILASTIC® 595 LSR, SILASTIC® 596 LSR, and SILASTIC® 598 LSR from Dow Corning.

Furthermore, in embodiments, the polymeric material of the blanket 12 is combined with a white or gray filler wherein the filled surface has an optical density in the visible spectrum of less than 0.9, or less than 0.6 or lese than 0.3. The filler is at a sufficient loading level so as to allow the overall composite material to contain a combined set of desired material properties. The optical properties including scattering are important, as fillers exhibit a wide range of scattering coefficients. This selected filler material is well dispersed within the bulk material, which is a combined function of the filler properties provided by the appropriate selection of the filler morphology, shape, and loading, and by proper dispersion techniques such as mechanical stirring, mill compounding, and/or sonication (depending on the physical state of the bulk material). Furthermore, the combined morphology, successful dispersion at adequate loading, as well as requiring the overall material to properly reflect blue light (about 445 nm), green light (about 532 nm) and red light (about 635 nm) so that the optical density less than about 0.9 which provides the background required to image an ink drop having a size of from about 20 microns to about 80 microns.

In an embodiment, a white filler with material substrate is precipitated calcium carbonate or PCC (which is used to improve the opacity and brightness in other materials such as paper). The PCC reflects incident light having wavelengths in the visible range of about 400 nm to about 700 nm, as well as provide the best optical performance in terms of scattering coefficient. A filler loading in the range of 5 weight percent to about 15 weight percent within the material substrate that, well dispersed with a narrow morphology variation is suitable. Other potential fillers that would aid in providing the desired properties could be, but are not limited to, metal oxides or metal nitrides such as magnesium oxide, calcium hydroxide, clay, titanium dioxide, calcium carbonates, talcs (magnesium silicate, magnesium calcium silicate), barium sulfate fillers (barites, blanc fixe), etc.

This allows the signal/noise ratio of the optical sensors (94A-D) an image sensor measurement that will be able to differentiate ink drops or plurality of ink drops of different colors (e.g. cyan, magenta, yellow and black). When light or radiation having a blue component is directed at the surface of the intermediate transfer member, yellow ink drops will absorb the blue component and the reflected light detected by the optical sensors will have less blue component. Likewise, when light or radiation having a green component is directed at the surface of the intermediate transfer member, magenta ink drops will absorb the green component and the reflected light detected by the optical sensors will have less red component. Likewise, when light or radiation having a red component is directed at the surface of the intermediate transfer member, cyan ink drops will absorb the red component and the reflected light detected by the optical sensors will have less green component. The black ink drops will absorb all visible wavelengths of light. Thus, the optical sensors can produce image data that allows one to; detect an ink drop; determine the size of an ink drop; and determine the placement of an ink drop.

In embodiments, the optical sensors can be set up for specular measurements then the required densities are relative to specular densities and vice versa. For example a mirror like surface will have reflect most of the incident light specularly and a very little light diffusely and so should be paired only with a specular image sensor arrangement.

The print cycle is monitored and controlled by the controller analyzing image data from the optical sensors 94A to 94D in FIG. 1. The print cycle is monitored for the following parameters, the absence of an ink drop, the misplacement of an ink drop or a size variation in an ink drop. By determining one the parameters is out of specification, printhead performance, printhead alignment, and printhead timing can be adjusted to bring the parameter within specification.

Printhead alignment includes detection of individual printhead roll and alignment between multiple printheads with reference to one another in the cross-process direction. Printhead timing refers to the delivery of the firing signals to the printheads so that each printhead and/or each inkjet in each printhead fires at the correct time in the process direction with respect to the other printheads or inkjets. The intensity of the color of the ink ejected by a printhead or even by inkjets within a printhead can vary. Consequently, the drop size of printheads and/or inkjets within a printhead is inferred from local changes in the light incident on the sensor and, if the variation exceeds a parameter, adjustments made to either the input image map data (e.g. the toner reproduction curve) or to the firing signals controlling the individual droplet ejectors on the printhead. Printhead performance includes detecting and compensating for weak and missing inkjets.

Color absorption spectrum of each ink, of the blanket, and of the optical sensor (i.e. the colors) as discussed above yields detailed information of an ink drop and determines the signal to noise ratio enabling the consistent measurement of this information. By measuring at least black, yellow (blue absorbing), magenta (green absorbing) and cyan (red absorbing) inks separately each ink drop is characterized. In one embodiment, a single broad wavelength optical sensor and light source is utilized. In another embodiment, separate color measurements are made dependent on the ink to be sensed. The optical properties of the blanket are acceptable at each of at least these three spectral regions corresponding to the inks.

The amount and the droplet size of ink can be measured for any color. The signal/noise is dependent on the ratio of the optical density of the drop to the optical density variations of the surface material that occur on the length scan of the drop.

The blanket optical density at each wavelength or color (e.g. red, green, and blue densities) is low enough so that the difference between the optical signal in the bare areas of the blanket and the partially ink covered areas exceeds the variation in either of these signals (for the case of pixel drop identification). The grey or white color density requirement of the blanket allows one to determine individual red, green and blue densities of the corresponding cyan, magenta and yellow ink drops.

The optical density of the blanket in the spectral regions of the inks to be measured must be less than about 0.9 for each of red (for detecting cyan ink) at a wavelength of about 635 nm, green (for detecting magenta ink) at a wavelength of about 532 nm, blue (for detecting yellow ink) at a wavelength of about 445 nm and be less than about 0.6 for neutral or white spectrums. In embodiments the different color ink drops can be measured with the same relative angle.

While measuring any given ink color type, if the optical sensor is sensitive to spectral regions not corresponding to the absorption region of the ink color, the densities of the blanket's optical densities in these other regions does not vary by more than 0.3 optical density relative to the blanket density in the spectral region corresponding to the absorption region of the ink color.

The surface of the transfer member optical density spatial variation is less than 0.3. Such a uniform density at the surface is critical component in having a suitable signal to noise ratio.

In addition to controlling the printhead, temperature control for ink drop coalescence can be modulated to increase or decrease the evaporation rate of any ink drop. Temperature control has to be balanced with the competing concern that high temperatures in the print zone may cause ink to dry in the inkjet nozzles or evaporated water to condense on printhead faces. Thus, the temperature in the print zone is controlled to begin ink drying, but most of the water/solvent evaporation is done in the drying zone. Temperature can be adjusted to reduce coalescence of ink drops. As used in this document, “coalescence” refers to an ink drop merging with an adjacent ink drop. Primary controls for coalescence on an imaging surface include regulation of temperatures in the print zone and drying zone.

In some embodiments, the optical sensors 94A to 94D have a resolution on the order of the features of drop coalescence that are being measured. Regulation of drop coalescence to the degree required for high image quality, however, necessitates ink drop boundary control to a precision higher than the resolution of such sensors. This precision can be accomplished by making repeat measurements for both the same nozzles and simultaneous measurements for different nozzles across the printhead.

In embodiments, the blanket can be absorbing in the IR (infrared) spectrum. In some cases ink dryers utilize IR radiation to dry the ink. If the blanket absorbs the IR then the surface will heat up and improve the ink drying. Otherwise the IR radiation is lost as it travels through the blanket or is reflected away from the ink. In embodiments, the surface absorbs at least 75 percent of the IR radiation from the IR radiation used to dry the ink.

It will be appreciated that variations of the above-disclosed apparatus and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

1. A method of operating an aqueous ink jet printing apparatus, the printing apparatus comprising a member defining a reflective imaging surface wherein the imaging surface is substantially white or grey in the visible spectrum and wherein the imaging surface has an optical density variation of less than about 0.3, and a photosensor array disposed to receive light reflected from the reflective imaging surface, the method comprising:
ejecting aqueous ink onto the reflective imaging surface using a printhead and forming aqueous ink drops on the surface;
transferring the aqueous ink drops to a media substrate;
generating image data from the reflecting imaging surface prior to the transfer of the aqueous ink drops to the media substrate using the photosensor array; and
identifying a parameter from the generated image data on the reflecting imaging surface that is not within specification.

2. The method of claim 1, wherein the parameter is selected from the group consisting of: an absence of an ink drop, a misplacement of an ink drop and an ink drop size variation.

3. The method of claim 2, wherein the absence of an ink drop, the misplacement of an ink drop and the ink drop size variation is indicative the printhead not operating to specification or printhead mis-alignment.

4. The method of claim 1, wherein the reflective imaging surface comprises an elastomeric matrix having filler particles dispersed therein.

5. The method of claim 4, wherein the elastomeric matrix is a material selected from the group consisting of: silicones, fluorosilicones, polyimides and fluoropolymers.

6. The method of claim 1, wherein the reflective imaging surface absorbs 75 percent of incident IR radiation.

7. The method of claim 1, wherein aqueous ink drops comprise a cyan color and a red filter or red illumination is used to generate the image data and the optical density of the reflective imaging surface under red illumination is less than about 0.9.

8. The method of claim 1, wherein aqueous ink drops comprise a magenta color and a green filter or green illumination is used to generate the image data and the optical density of the reflective imaging surface under green illumination is less than about 0.9.

9. The method of claim 1, wherein aqueous ink drops comprise a yellow color and a blue filter or blue illumination is used to generate the image data and the optical density of the reflective imaging surface under blue illumination is less than about 0.9.

10. A printer comprising:
at least one printhead configured to eject aqueous ink drops;
a rotating member positioned to rotate in front of the at least one printhead to enable the at least one printhead to eject aqueous ink drops onto a surface of the rotating member and form an aqueous ink image on the surface of the rotating member, wherein the rotating member includes a reflective imaging surface wherein the reflective imaging surface is substantially white or grey in the visible spectrum, and wherein the reflective imaging surface has an optical density variation of less than about 0.3;
a nip for transferring the aqueous ink image to a media substrate;
at least one optical sensor disposed to receive light reflected from the reflective imaging surface and to generate image data from the aqueous ink image wherein the at least one optical sensor is positioned before the nip; and
a controller operatively connected to the at least one optical sensor, the controller being configured to receive the image data and identify a parameter from the generated image data on the reflective imaging surface that is not within specification.

11. The printer of claim 10, wherein the parameter is selected from the group consisting of: an absence of an ink drop, a misplacement of an ink drop and an ink drop size variation.

12. The printer of claim 10, wherein the absence of an ink drop, the misplacement of an ink drop and the ink drop size variation is indicative the printhead not operating to specification or printhead mis-alignment.

13. The printer of claim 10, wherein the rotating member comprises an elastomeric matrix selected from the group consisting of silicones, fluorosilicones, polyimides and fluoropolymers having filler particles dispersed therein.

14. The printer of claim 13, wherein the filler particles are selected from the group consisting of magnesium oxide, calcium hydroxide, clay, titanium dioxide, calcium carbonate, talcs, and barium sulfate and the filler particles comprise from about 5 weight percent to about 15 weight percent of the rotating member.

15. The printer of claim 10, wherein the reflective imaging surface absorbs 75 percent of incident IR radiation.

16. The printer of claim 10, wherein aqueous ink drops comprise a cyan color and a red filter or red illumination is used to generate the image data and the optical density of the reflective imaging surface is less than about 0.9.

17. The printer of claim 10, wherein aqueous ink drops comprise a magenta color and a green filter or green illumination is used to generate the image data and the optical density of the reflective imaging surface is less than about 0.9.

18. The printer of claim 10, wherein aqueous ink drops comprise a yellow color and a blue filter or blue illumination is used to generate the image data and the optical density of the reflective imaging surface is less than 0.9.

19. A method of operating an aqueous ink jet printing apparatus, the printing apparatus comprising a member defining a reflective imaging surface wherein the reflective imaging surface is substantially white or grey in the visible spectrum and wherein the reflective imaging surface has an optical density variation of less than about 0.3, and a photosensor array disposed to receive light reflected from the reflective imaging surface, the method comprising:
ejecting aqueous ink onto the reflective imaging surface using a printhead and forming a plurality of aqueous ink drops on the surface of the rotating member, wherein the aqueous ink drops are of a cyan color, a magenta color, a yellow color and a white color;
transferring the plurality of aqueous ink drops to a media substrate;
generating image data from the reflecting imaging surface prior to the transfer of the plurality of aqueous ink drops to the media substrate using the photosensor array; and
identifying a parameter from the generated image data on the reflecting imaging surface that is not within specification.

20. The method of claim 19, wherein the parameter is selected from the group consisting of: an absence of an ink drop, a misplacement of an ink drop and an ink drop size variation.
